(19) United States
(12) Patent Application Publication
(10) Pub. No.: US 2026/0229647 A1
(43) Pub. Date: Aug. 6, 2026

(54) INSULATION ELEMENT, METHOD FOR PRODUCING AN INSULATION ELEMENT, AND HOUSING COMPONENT HAVING AN INSULATION ELEMENT

(71) Applicant: ElringKlinger AG, Dettingen (DE)

(72) Inventor: Sebastian WEYH, Dettingen (DE)

(73) Assignee: ElringKlinger AG, Dettingen (DE)

(21) Appl. No.: 19/562,638

(22) Filed: Mar. 10, 2026

Related U.S. Application Data
(63) Continuation of application No. PCT/EP2024/075144, filed on Sep. 9, 2024.

(30) Foreign Application Priority Data
Sep. 11, 2023 (DE) 10 2023 124 415.9

(51) Int. Cl. H01M 10/658; H01M 50/117; H01M 50/124; H01M 50/131

(52) U.S. Cl. CPC H01M 10/658; H01M 50/117; H01M 50/1243; H01M 50/1245; H01M 50/131; H01M 2220/20

(57) ABSTRACT

An insulation element, in particular for insulating housing components of energy stores or energy converters, for example for an electrically powered motor vehicle, wherein the insulation element comprises or is made of an insulation material, wherein the insulation material comprises or is made of at least one additive, in particular for increasing a thermal and/or electrical and/or mechanical resistance of the insulation element. Furthermore, A method for manufacturing the insulation element is provided.

### RELATED APPLICATION

This application is a continuation of international application No. PCT/EP 2024/075144 filed on Sep. 9, 2024, and claims the benefit of German application No. DE 10 2023 124 415.9 filed on Sep. 11, 2023, which are incorporated herein by reference in their entirety and for all purposes.

### FIELD OF DISCLOSURE

The present invention relates to an insulation element, a method for producing an insulation element, and a housing component having an insulation element.

### BACKGROUND

In housing components of energy stores or energy converters, in particular of batteries, accumulators or fuel cells, there is the risk of so-called thermal breakdowns (also referred to as thermal runaways). A thermal breakdown generally denotes the overheating of an exothermic chemical reaction or of technical equipment due to a process that produces self-intensifying heat. A runaway frequently leads to fire or explosion and consequently brings about destruction of the equipment as a result of overpressure (bursting). Hereinafter, for the sake of simplicity, the terms energy store and energy converter will be used synonymously, i.e. the configurations and advantages presented with reference to energy stores also apply analogously to energy converters, and vice versa.

It is therefore necessary to protect housings of such energy stores against thermal runaways, so that propagation to other constituents within and/or outside the energy store can be prevented.

Known solutions, however, are heavy, take up a large volume and in some cases have a complex multi-layer construction. Furthermore, such solutions are often unable to offer comprehensive protection.

### SUMMARY OF THE INVENTION

The present invention is therefore based on the object of specifying an insulation element that comprises reliable and at the same time simple protection, in particular against thermal and/or electrical runaways. The present invention is furthermore based on the object of specifying a method for producing such an insulation element.

With regard to the insulation element, the object is achieved according to the invention by an insulation element having the features of the independent claim(s). With regard to the method, the object is achieved according to the invention by a method having the features of at least the dependent claims. Advantageous configurations, developments and variants are specified in the dependent claims. The advantages and preferred configurations presented with respect to the housing component are to be applied analogously to the method, and vice versa.

Specifically, the object directed to the insulation element is achieved by an insulation element, in particular for insulating housing components of energy stores, for example for an electrically powered motor vehicle, wherein the insulation element comprises or is made of an insulation material. The insulation material is used in particular to prevent a thermal and/or electrical breakdown of the housing component.

However, the application is not limited to housing components of energy stores, and therefore other components which require insulation of the type mentioned at the outset can also be included.

In this case, the insulation material comprises or is made of at least one additive. The additive is used in particular to increase a thermal and/or electrical and/or mechanical resistance of the insulation material.

Reliable protection of the housing component is therefore achieved, without having to have recourse to the large-volume and complex insulation elements already mentioned, which therefore also simplifies the overall construction of the housing component to be protected.

According to one embodiment, the insulation element comprises an insulation paper. As an alternative to this, the insulation element is formed as an insulation paper. In this case, the insulation material, together with the at least one additive, is preferably either applied to the insulation paper or incorporated into the insulation paper. As a result of the configuration of the insulation element as an insulation paper, a more universal and application-friendly insulation element is created, which can be processed simply and is adaptable in a versatile manner to different types of housing components.

In order to allow for an insulation element that is as thin as possible compared to the known solutions, the insulation element has a thickness with a value in the range from 0.2 mm to 2 mm, preferably in the range from 0.5 mm to 1.5 mm, in particular of 1 mm. The insulation element is therefore thin enough to offer a simple configuration that saves construction space, yet thick enough to meet the protection requirements.

It may be advantageous if the insulation element contains the insulation material completely or in regions or is made of the insulation material completely or in regions. In this case, vulnerable regions of the housing component, for example, can be particularly protected by the part of the insulation element that comprises the insulation material, while other regions of the housing component are protected by the insulation element alone. When the insulation element is applied or attached completely, preferably at least all the outer regions and sides of the housing component are surrounded by the insulation element. In this connection, it may alternatively also be envisioned that the housing component comprises a plurality of constituents, for example two constituents, both of which are provided with the insulation element completely or in regions and are joined together, for example.

According to a preferred configuration, the at least one additive comprises or is made of an intumescent material.

Within the context of the present application, the term intumescent material can be understood to mean a material that increases in volume and correspondingly decreases in density under the effect of heat. For example, the intumescent material can form a foamed layer of ash that prevents the supply of oxygen and thus the propagation of flames. In detail, in the active state, i.e. upon the input of heat (such as in the case of a thermal breakdown, for example), intumescent material forms a swollen layer. This layer has a very low density, but is resistant to thermal influences. Therefore, in the event of a thermal runaway, the intumescent material forms a heat-resistant protective layer that protects in particular against the impingement of abrasive particles under high temperature, as arise during such a thermal breakdown.

In particular, the intumescent material is one of the following materials:
water-based intumescent material,
solvent-based intumescent material, or
epoxy-based intumescent material.

A water-based intumescent material has the advantage that it is environmentally friendly and inexpensive.

By contrast, a solvent-based intumescent material offers the advantage that it has a smooth finish and thus in particular forms a smooth and clean surface. A smooth and clean surface is significant because dusty and porous or rough surfaces increase the chances of a thermal breakdown and are therefore undesirable.

An epoxy-based intumescent material offers the advantage that it is extremely resistant and thus can also be used in “rough” environments, without reducing or losing its protective effect.

In particular the thermal properties of intumescent materials are determined especially by their chemical composition. Particularly suitable intumescent materials comprise a water-soluble alkali-silicate binder, for example. Such materials comprise a silica portion of at most 96% and a portion of N-octyl-2-pyrrolidone in the range between 0.1% and 1%, for example.

Alternatively or additionally, the at least one additive comprises or is made of a thermal insulation material, in particular an aerogel. Such thermal insulation materials have a low thermal conductivity and, as a result, increase the thermal resistance of the insulation element and thus of the housing component. These materials are often also certified, and therefore they offer a guarantee of thermal resistance and thus can comply with and meet standards required by authorities. Such a certificate or test is the UL94 flame test, for example. By forming the additive as a thermal insulation material, the thermal protection of the insulation element can therefore be increased. In addition to the thermal protective effect of an aerogel, it also protects against an electrical disruptive discharge and therefore, in addition, the electrical resistance during use of an aerogel can also be improved. This further advantage is based on the property whereby good thermal conductors usually also have good electrical conductivity. Consequently, in addition to their main purpose as thermal insulators, they can also be used as electrical insulation materials.

Suitable aerogels are those which are formed as hydrophilic and synthetic highly amorphous silicate solids, for example. Such aerogels have particle sizes in the range from 1 to 70 μm, preferably in the range from 1 to 20 μm and especially in the range from 10 to 15 μm, for example. Furthermore, these aerogels have pore sizes in the range from 1 to 50 nm, preferably in the range from 10 to 30 nm and especially in the range from 15 to 25 nm. The thermal conductivity of such aerogels has a value in the range between 0.025 and 0.03 W/(mK).

According to a further alternative or additional embodiment, the at least one additive comprises or is made of a nonwoven and/or fibers. Such fibers increase the mechanical structure of the insulation element and thus the protective effect against mechanical stresses. Examples of such fibers may be AES wool, an insulation nonwoven, glass fibers and/or metal fibers and/or metal alloy fibers and/or ceramic fibers.

To increase both the electrical and the mechanical resistance of the insulation element, the at least one additive can comprise or be made of ceramic particles. Protection against an AC/DC breakdown voltage, for example, is therefore increased.

Specifically, the object directed to the method is achieved by a method for producing an insulation element. The method includes the following steps:
providing an insulation element;
adding and/or applying an insulation material into or onto the insulation element;
drying the insulation element.

The provision of the insulation element preferably takes place in a space intended for coating.

For the addition or application of the insulation material to or into the insulation element, application methods which are already known can preferably be used. Such methods are for example—but not limited to—spraying on, electroplating, powder coating or thermal spraying. By employing methods which are already known, inexpensive production of the insulation element can therefore be achieved.

According to one embodiment of the method, the insulation material is added to the insulation element completely or in regions and/or the insulation material is applied onto the insulation element completely or in regions. As a result, an individual protective capacity of the insulation material is achieved, and therefore the insulation element can be adapted to its use on the housing component.

In an advantageous manner, at least one additive is admixed with the insulation material or the insulation material is at least one additive. This configuration allows for an increase in the protective effect of the insulation element.

Furthermore, as part of this application, a housing component is disclosed and claimed, in particular for an energy store, for example for an electrically powered motor vehicle, wherein an insulation element is attached, in particular adhesively bonded, to an inner side and/or an outer side of the housing component. The insulation element is in particular the insulation element already described.

The housing component can be, in particular, an energy store and for example an energy store for an electrically powered motor vehicle. If the protective element forms at least part of the housing component, the housing component is preferably, but not in a limiting manner, formed in multiple parts, such that at least part of the housing component is made of the protective element. However, it is also conceivable that the entire housing component is made of the protective element, in particular consists of the protective element.

The insulation element is preferably attached, in particular adhesively bonded, to the inner side and/or the outer side of the housing component completely or in regions. Further preferred features and/or advantages of the invention are the subject matter of the following description and the drawings that depict exemplary embodiments.

### IN THE DRAWINGS

FIG. 1 shows a schematic depiction of an insulation element according to the invention according to a first embodiment having an insulation material that is completely embedded in the insulation element;

FIG. 2 shows a schematic depiction of an insulation element according to the invention according to a second embodiment having an insulation material that is embedded in regions of the insulation element;

FIG. 3 shows a schematic depiction of an insulation element according to the invention according to a third embodiment having an insulation material that is applied completely to an upper side of the insulation element;

FIG. 4 shows a schematic depiction of an insulation element according to the invention according to a fourth embodiment having an insulation material that is applied to regions of an upper side of the insulation element;

FIG. 5 shows a schematic depiction of an insulation element according to the invention according to a fifth embodiment having an alternative insulation material that is completely embedded in the insulation element;

FIG. 6 shows a schematic depiction of an insulation element according to the invention according to a sixth embodiment having an alternative insulation material that is embedded in regions of the insulation element;

FIG. 7 shows a schematic depiction of an insulation element according to the invention according to a seventh embodiment having an insulation material that is applied completely to an upper side of the insulation element;

FIG. 8 shows a schematic depiction of an insulation element according to the invention according to an eighth embodiment having an insulation material that is applied to regions of an upper side of the insulation element;

FIG. 9 shows a schematic depiction of a housing component that comprises an insulation element on an inner side and on an outer side;

FIG. 10 shows a schematic depiction of a block diagram of a method for producing an insulation element having an insulation material. Identical or functionally equivalent elements are provided with the same reference signs in all the figures.

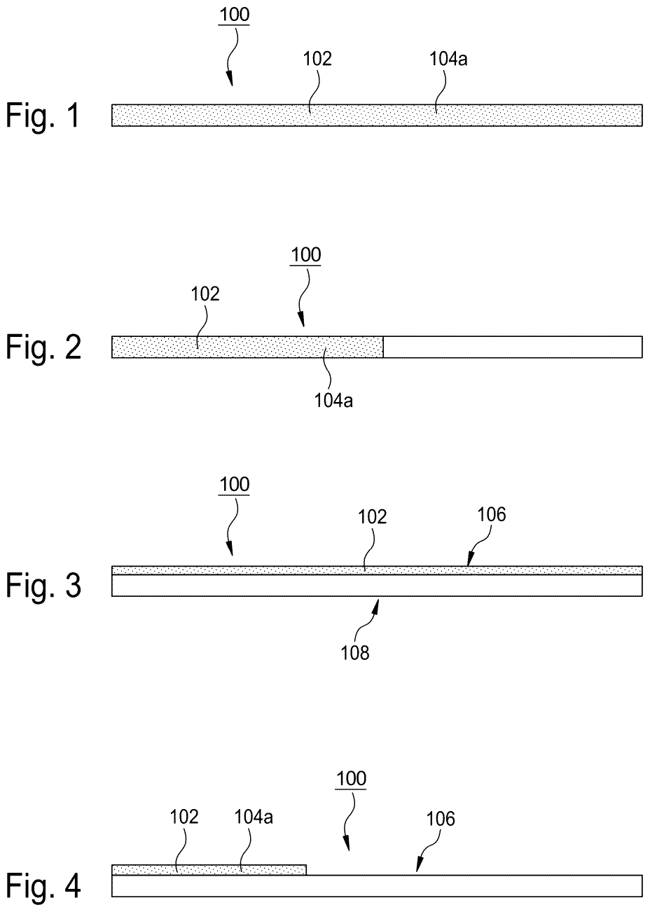

With reference to FIG. 1, a schematic depiction of an insulation element 100 according to a first embodiment is shown. The insulation element 100 is preferably designed for a housing component and in particular for a housing component of an energy store, for example for an electrically powered motor vehicle.

The insulation element 100 is preferably formed as an insulation paper. Furthermore, it comprises or is made of an insulation material 102. The insulation material 102 is used in particular to increase a thermal and/or electrical and/or mechanical resistance of the insulation material 102 and thus also of the insulation element 100.

In the exemplary embodiment according to FIG. 1, the insulation material 102 is completely embedded in the insulation element 100. In other words, the insulation element 100 preferably has the same concentration of the insulation material 102 at every point. Alternatively, the concentration of the insulation material 102 within the insulation element 100 can vary in regions.

To further increase the resistance already mentioned, the insulation element 100 furthermore comprises an additive 104a, which is a thermal insulation material in the exemplary embodiment according to FIG. 1. This is depicted graphically by the dotted patterning in FIG. 1.

Aerogels, for example, have proven to be advantageous as suitable thermal insulation materials. Such materials can increase resistance to heat by several hours.

Furthermore, the insulation element 100 can comprise an adhesive layer, not depicted, on one or more outer sides, by means of which adhesive layer said insulation element 100 is attached, in particular adhesively bonded, to the housing component.

The insulation material 100 preferably has a thickness with a value in the range from 0.2 mm to 2 mm, preferably in the range from 0.5 mm to 1.5 mm, in particular of 1 mm. Therefore, in the figures, the insulation element 100 is not depicted to scale, but rather greatly enlarged for better clarification of the features.

In the case of the insulation element 100 according to a second embodiment of the invention, depicted schematically in FIG. 2, the insulation material 102 is embedded only in regions, specifically—when viewed in the image plane—in the left half of the insulation element 100. Here, the right half comprises only the carrier material of the insulation element 100, for example.

In a similar manner, the insulation element 100 according to FIG. 2 additionally comprises the additive 104a also only in the left-hand region, which additive 104a is embedded in the insulation element 100 together with the insulation material 102. By means of this configuration, the left-hand region of the insulation element 100 can offer particular protection against heat stress, for example.

Otherwise, the embodiment of an insulation element 100 depicted in FIG. 2 matches the embodiment depicted in FIG. 1 in terms of construction and function, and therefore reference is made to the description thereof above in this respect.

The third embodiment of the insulation element 100 according to the invention, depicted schematically in FIG. 3, likewise comprises an insulation material 102. However, in contrast to the two exemplary embodiments described above, said insulation material 102 is arranged on an upper side 106 of the insulation element 100. In particular, the insulation material 102 is applied to the upper side 106 of the insulation element 100, for example sprayed on. In other words, the insulation material 102 is situated only at or on the surface of the insulation element 100 in the manner of a layer.

Additionally, the insulation material 102 is applied completely to the upper side 106 of the insulation element 100, and therefore covers the surface of the insulation element 100 completely. It goes without saying that, alternatively or additionally, the insulation material 102 can also be arranged on, in particular applied to, a lower side 108 of the insulation element 100 in an analogous manner.

Furthermore, the insulation material 102 likewise comprises an additive 104a, which is applied to the upper side 106 in an analogous manner.

Otherwise, the embodiment of an insulation element 100 depicted in FIG. 3 matches the embodiments depicted in FIGS. 1 and 2 in terms of construction and function, and therefore reference is made to the description thereof above in this respect.

FIG. 4 shows a schematic depiction of an alternative, fourth embodiment to the third embodiment shown in FIG. 3.

In this case, the insulation material 102 is arranged on the upper side 106 of the insulation element 100 only in regions. Specifically, and when viewed in the image plane, the insulation material 102 is arranged only in the left-hand region on the upper side 106 of the insulation element 100 and thus also offers increased protection only there. Otherwise, the embodiment of an insulation element 100 depicted in FIG. 4 matches the embodiments depicted in FIGS. 1 to 3 in terms of construction and function, and therefore reference is made to the description thereof above in this respect.

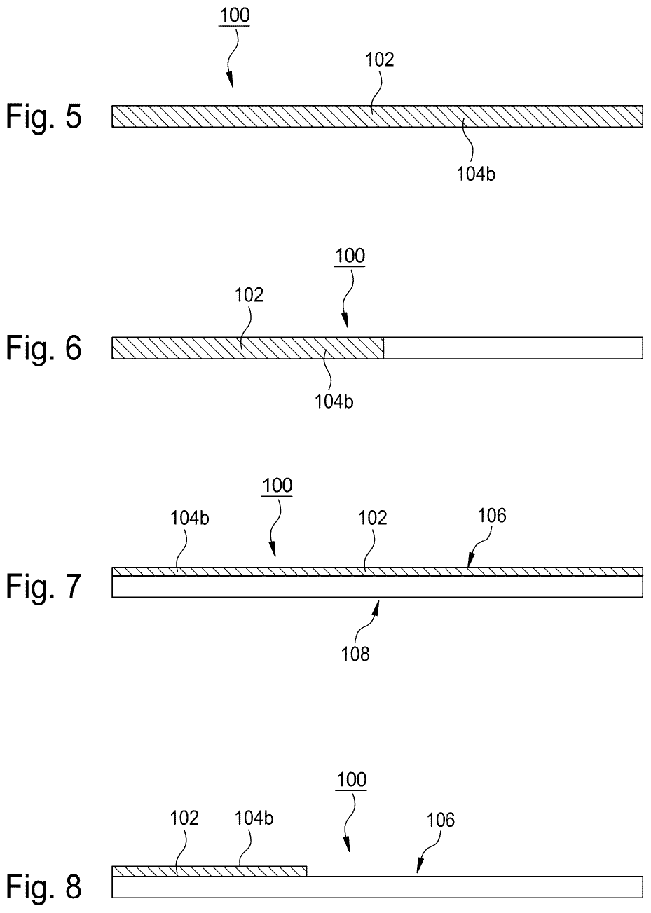

A fifth embodiment of the insulation element 100 according to the invention can be seen schematically in FIG. 5.

In the fifth embodiment of the insulation element 100, the insulation material 102—analogously to the first embodiment—is completely embedded into the insulation element 100.

In other words, the insulation element 100 preferably has the same concentration of the insulation material 102 at every point.

The exemplary embodiment according to FIG. 5, however, has an alternative additive 104b that is depicted graphically by the striped patterning of the insulation element 100.

The additive 104b according to FIG. 5 is fibers, in particular glass fibers and/or metal fibers and/or metal alloy fibers and/or ceramic fibers. Silicate fibers are also conceivable, for example, which have proven to be particularly suitable. The use of fibers as additive 104b increases in particular the mechanical resistance of the insulation material 102 and thus of the insulation element 100. If the fibers are ceramic fibers, these additionally also increase the electrical resistance due to their electrically insulating nature.

Otherwise, the embodiment of an insulation element 100 depicted in FIG. 5 matches the embodiments depicted in FIGS. 1 to 4 in terms of construction and function, and therefore reference is made to the description thereof above in this respect.

In the case of the insulation element 100 according to a sixth embodiment of the invention, depicted schematically in FIG. 6, the insulation material 102 is embedded only in regions, specifically—when viewed in the image plane—in the left half of the insulation element 100. Here, the right half comprises only the carrier material of the insulation element 100, for example.

In a similar manner, the insulation element 100 according to FIG. 6 additionally comprises the additive 104b made of the fibers described with reference to FIG. 5, also only in the left-hand region, which additive 104b is embedded in the insulation element 100 together with the insulation material 102.

By means of this configuration, the left-hand region of the insulation element 100 can offer particular protection against mechanical stress, for example. Otherwise, the embodiment of an insulation element 100 depicted in FIG. 6 matches the embodiments depicted in FIGS. 1 to 5 in terms of construction and function, and therefore reference is made to the description thereof above in this respect.

The schematic depiction in FIG. 7 shows a seventh embodiment of the insulation element 100 according to the invention.

The insulation element 100 likewise comprises an insulation material 102. However, said insulation material 102 is arranged on an upper side 106 of the insulation element 100, as in the exemplary embodiment according to FIG. 3. In particular, the insulation material 102 is applied to the upper side 106 of the insulation element 100, for example sprayed on. In other words, the insulation material 102 is situated only at or on the surface of the insulation element 100 in the manner of a layer.

Additionally, the insulation material 102 is applied completely to the upper side 106 of the insulation element 100, and thus covers the surface of the insulation element 100 completely. It goes without saying that, alternatively or additionally, the insulation material 102 can also be arranged on, in particular applied to, a lower side 108 of the insulation element 100 in an analogous manner.

Furthermore, the insulation material 102 likewise comprises the additive 104b made of fibers, which additive 104b is applied to the upper side 106 in an analogous manner.

Otherwise, the embodiment of an insulation element 100 depicted in FIG. 7 matches the embodiments depicted in FIGS. 1 to 6 in terms of construction and function, and therefore reference is made to the description thereof above in this respect.

FIG. 8 shows a schematic depiction of an alternative, eighth embodiment to the seventh embodiment shown in FIG. 7.

In this case, the insulation material 102 is arranged on the upper side 106 of the insulation element 100 only in regions. Specifically, and when viewed in the image plane, the insulation material 102 is arranged only in the left-hand region on the upper side 106 of the insulation element 100 and thus preferably also offers increased protection only there.

Otherwise, the embodiment of an insulation element 100 depicted in FIG. 8 matches the embodiments depicted in FIGS. 1 to 7 in terms of construction and function, and therefore reference is made to the description thereof above in this respect.

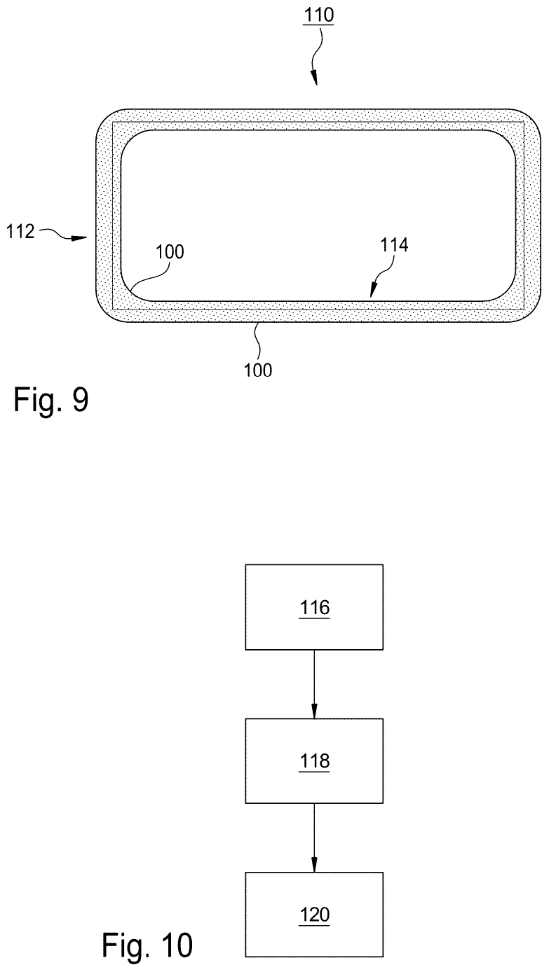

In FIG. 9, a housing component 110, in particular for an energy store, for example for an electrically powered motor vehicle, is depicted.

Alternatively, the housing component 110 can be an electrochemical cell, a battery cover or battery casing, a cell separator, an intercellular separator or generally a module of the energy store. In other words, each component that is formed in the manner of a housing and is, or can be, part of an energy store can be regarded as a housing component 110.

As per FIG. 9, the housing component 110 has an insulation element 100 on its outer side 112 and on its inner side 114 in each case. The insulation element 100 is, in particular, the above-described insulation element 100, and therefore reference is made to the description thereof above in this respect.

Alternatively, however, the housing component 110 can have an insulation element 100 only on its outer side 112 or on its inner side 114.

Therefore, the housing component 110 is sufficiently protected in a simple yet reliable manner against thermal and/or electrical and/or mechanical stresses.

FIG. 10 shows, in the form of a block diagram, the procedures of a method for producing an insulation element 100.

In a first step 116 of the method, an insulation element 100 is provided. The insulation element 100 is preferably uncoated at this stage. In other words, the insulation element 100 does not yet comprise any insulation material 102 at this stage.

The provision preferably takes place in an area provided for this purpose, for example in a coating chamber.

In the second step 118 of the method, the addition and/or application of the insulation material 102 into or onto the insulation element 100 takes place. For the addition of the insulation material 102 into the insulation element 100, the insulation material 102 is preferably introduced into the material of the insulation element 100. For the application of the insulation material 102 onto the insulation element 100, the insulation material 102 is preferably applied onto a surface of the insulation element 100 completely or in regions in the manner of a protective layer.

In the third step 120 of the method, the insulation element 100 provided with the insulation material 102 is dried. By means of the drying, the insulation element 100, and especially the insulation material 102, experiences a smoothing of its surface, which results in an abrasion-resistant surface that additionally reduces the adherence of dirt particles. Since the adherence of dirt particles, such as dust for example, leads to an increased risk of electrical disruptive discharges, a further advantage in terms of electrical protection can therefore be achieved.

In further (non-depicted) embodiments of insulation elements 100, individual or multiple features and/or advantages of the abovementioned embodiments can be combined with one another as desired. For example, even in the embodiment of an insulation element 100 depicted in FIG. 1, an insulation material 102 can additionally be provided with an alternative additive 104b on the upper side 106 according to the seventh embodiment depicted in FIG. 7.

### LIST OF REFERENCE SIGNS

100 insulation element
102 insulation material
104a, b additive
106 upper side of the insulation element
108 lower side of the insulation element
110 housing component
112 outer side of the housing component
114 inner side of the housing component
116 provision of an insulation element
118 addition and/or application of an insulation material into or onto the insulation element
120 drying of the insulation element

1. An insulation element which comprises or is made of an insulation material, wherein the insulation material comprises or is made of at least one additive.

2. The insulation element as claimed in claim 1, wherein the at least one additive is at least one additive for increasing
a thermal resistance and/or
an electrical resistance and/or
a mechanical resistance of the insulation element.

3. The insulation element as claimed in claim 1, wherein the insulation element comprises an insulation paper or is formed as an insulation paper.

4. The insulation element as claimed in claim 1, comprising a thickness with a value in the range from 0.2 mm to 2 mm, or from 0.5 mm to 1.5 mm, or a thickness of 1 mm.

5. The insulation element as claimed in claim 1, wherein the insulation element contains the insulation material completely or in regions or is made of the insulation material completely or in regions.

6. The insulation element as claimed in claim 1, wherein the at least one additive comprises or is made of an intumescent material.

7. The insulation element as claimed in claim 1, wherein the at least one additive comprises or is made of a thermal insulation material.

8. The insulation element as claimed in claim 7, wherein the thermal insulation material is an aerogel.

9. The insulation element as claimed in claim 1, wherein the at least one additive comprises or is made of a nonwoven and/or fibers.

10. The insulation element as claimed in claim 1, wherein the at least one additive comprises or is made of ceramic particles.

11. The insulation element as claimed in claim 1, wherein
the insulation element is formed as a single-layer insulation paper,
comprises a carrier material, and
comprises the insulation material, wherein
the insulation material comprises or is made of at least two additives which include
the at least one additive,
one of the at least two additives comprises or is made of an intumescent material,
a further of the at least two additives comprises or is made of a thermal insulation material, and
the thermal insulation material is an aerogel.

12. The insulation element as claimed in claim 1, wherein
the insulation element is formed as a single-layer insulation paper,
the insulation element comprises a carrier material,
the insulation element comprises the insulation material,
the insulation material comprises or is made of at least three additives which include the at least one additive,
one of the at least three additives comprises or is made of an intumescent material,
a further of the at least three additives comprises or is made of a thermal insulation material,
the thermal insulation material is an aerogel, and
a further of the at least three additives comprises or is made of ceramic particles.

13. The insulation element as claimed in claim 1, wherein
the insulation element comprises or is made of the insulation material,
the insulation material comprises or is made of at least one additive,
the at least one additive comprises or is made of an intumescent material,
the intumescent material is an epoxy-based intumescent material, and
the insulation element comprises an insulation paper or is formed as an insulation paper.

14. The insulation element as claimed in claim 1, wherein
the insulation element comprises or is made of the insulation material,
the insulation material comprises or is made of at least one additive,
the at least one additive comprises or is made of an intumescent material, and
the intumescent material comprises a water-soluble alkali-silicate binder.

15. A method for producing said insulation element as claimed in claim 1, the method comprising:
providing an insulation element;
adding and/or applying an insulation material into or onto the insulation element; and
drying the insulation element.

16. The method as claimed in claim 15, wherein the insulation material is added to the insulation element completely or in regions and/or the insulation material is applied onto the insulation element completely or in regions.

17. The method as claimed in claim 15, wherein the at least one additive is admixed with the insulation material or the insulation material is the at least one additive.

18. A housing component, wherein said insulation element, as claimed in claim 1 is attached or adhesively bonded to an inner side and/or to an outer side of the housing component.

19. The housing component as claimed in claim 18, wherein the insulation element is attached or adhesively bonded to the inner side and/or the outer side of the housing component completely or in regions.

20. An energy converter for an electrically powered motor vehicle, the energy converter comprising the housing component according to claim 18.
